(19) United States
(12) Patent Application Publication
(10) Pub. No.: US 2006/0069828 A1
(43) Pub. Date: Mar. 30, 2006

(54) Sharing a physical device among multiple clients

(76) Inventor: Michael A. Goldsmith, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,458

(22) Filed: Jun. 30, 2004

(51) Int. Cl. G06F 13/00

(52) U.S. Cl. 710/100

(57) ABSTRACT

A physical device has core function circuitry that is to perform a core I/O function of a computer system. Multiple client interface circuits are provided, each of which presents itself as a complete device to a software client in the system, to access the core function circuitry. Multiplexing circuitry couples the client interfaces to the core I/O functionality. Other embodiments are also described and claimed.

### BACKGROUND

An embodiment of the invention relates generally to computer systems and particularly to virtualization techniques that allow a physical device to be shared by multiple programs.

With the prevalence of different computer operating system (OS) programs (e.g., LIMUX, MACINTOSH, MICROSOFT WINDOWS), consumers are offered a wide range of different kinds of application programs that unfortunately are not designed to run over the same OS. Virtualization technology enables a single host computer running a virtual machine monitor (“VMM”) to present multiple abstractions of the host, such that the underlying hardware of the host appears as one or more independently operating virtual machines (“VMs”). Each VM may function as a self-contained platform, running its own operating system (“OS”) and/or one or more software applications. The VMM manages allocation of resources on the host and performs context switching as necessary to multiplex between various virtual machines according to a round-robin or other predetermined scheme. For example, in a VM environment, each OS has the illusion that it is running on its own hardware platform or “bare metal”. Each OS “sees” a full set of available I/O devices such as a keyboard controller, a hard disk drive controller, a network interface controller, and a graphics display adapter.

The following techniques are used when an operating system is to communicate with an I/O device. If the OS is actually running on the bare metal, a hardware client interface of a physical I/O device is exposed on a bus. The client interface may be a set of memory-mapped registers (memory mapped I/O, MMIO) or an I/O port (IOP), and can be addressed through a memory mapped I/O address space or through an I/O address space of the computer system, respectively. A processor can then read or write locations in the physical device by issuing OS transactions on the bus that are directed to the assigned address space.

On the other hand, with virtualization, there may be multiple VMs (for running multiple guest OSs). In that case, two basic techniques are used to provide I/O capability to the guests. In the first, the VM is given exclusive access to the device. The VMM arranges for all access by the VM to MMIOs or IOPs to be sent directly to the targeted I/O device. In this way, the VM has the maximum performance path for communicating with the device. This technique is sometimes called device assignment. Its primary limitation is that the I/O device can only be assigned to a single VM.

If it is desired that an I/O device be shared in some fashion among multilple VMs, a common technique is for the VMM to emulate the physical I/O device, as one or more “virtual devices”. Transactions from a particular OS that are directed to the physical device are then intercepted by the VMM. The VMM can then choose to emulate a device (for example, by simulating a serial port using a network interface) or it can multiplex the requests from various client VMs onto a single I/O device (for example, partitioning a hard drive into multiple virtual drives).

Another way to view the virtualization process is as follows. A VM needs to have access to a set of I/O devices, which may include both virtual and physical devices. If a physical device is assigned to a single VM, it is not available to the other virtual machines. Accordingly, if a physical device needs to be shared by more than one VM, the VMM typically implements a virtual device for each VM. The VMM then arbitrates access of the same hardware client interface of the physical device by the virtual devices.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a block diagram of a physical device that is “shareable by design”.

FIG. 2 depicts a block diagram of a computer system having a shareable device and that is running a virtualization process.

FIG. 3 shows a flow diagram of a virtualization process involving the discovery of a shareable I/O device in a computer system.

### DETAILED DESCRIPTION

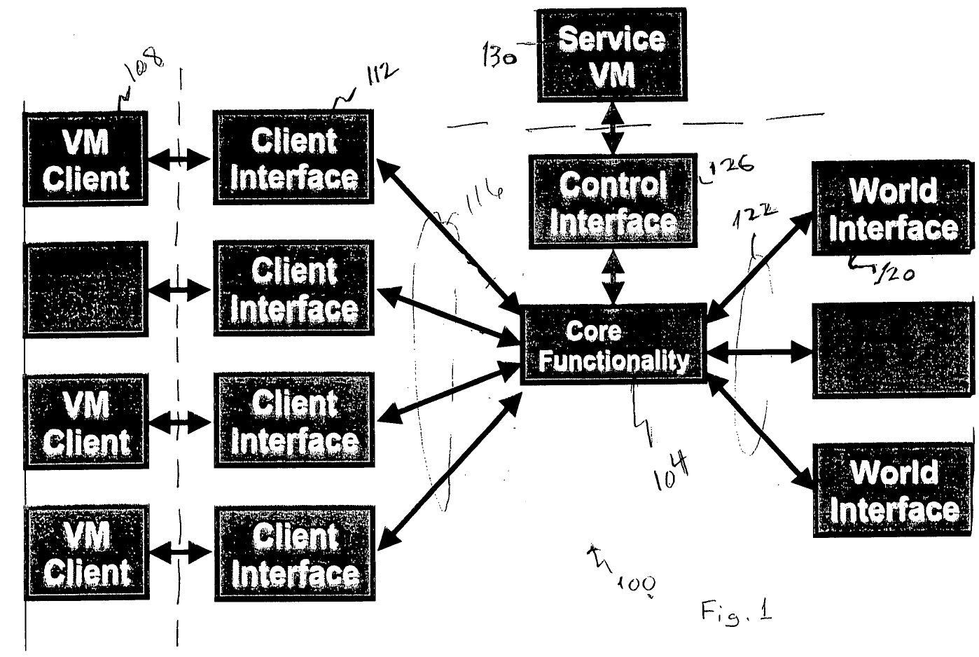

FIG. 1 illustrates a block diagram of a physical device that is “shareable by design”. This shareable device 100 has core function circuitry 104 that is to perform, in this example, a core I/O function of a computer system. Examples of the core I/O function include image rendering in the case of a graphics adapter, and Transport Control Protocol/Internet Protocol (TCP/IP) packet offloading for a network interface controller. The core I/O function circuitry may be implemented as a combination of hardwired and/or programmable logic and a programmed processor or any other technique well-known to one skilled in the art.

A software virtual machine (VM) client 108 in the system is to access the core function circuitry 104 via any one of multiple, client interface circuits 112 (or simply, client interfaces 112). The VM client 108 may be an operating system such as MICROSOFT WINDOWS or LINUX containing a device driver. The client interfaces 112 are coupled to the core function circuitry 104 via multiplexing circuitry 116, to enable the sharing of core functionality by the VM clients via the client interfaces. The multiplexing circuitry 116 may include both multiplexor logic and signal lines needed to connect the core function circuitry to any one of the client interfaces 112 at a time.

Each client interface 112 presents itself as a complete and separate device to a software client in the system, such as the VM client 108. The interface 112 may implement all aspects of the functionality required by a bus on which it resides. The client interface 112 may include analog circuits that translate between logic signaling in the device and external bus signaling. If the external bus is of the serial, point-to-point variety, then a multiplexing switch circuit may be added to connect, at any one time, one of the set of registers to the transmission medium of the bus.

In some embodiments of the invention, each client interface 112 may support the same Peripheral Components Interconnect (PCI)-compatible configuration mechanism and the same function discovery mechanism on the same bus (to which the physical device is connected). However in such an embodiment each client interface would provide a different PCI device identification number (because each effectively represents a different device). In addition, each client interface would identify a separate set of PCI-compatible functions. A client interface may of course be designed to comply with other types of I/O or bus communication protocols used for example in connecting the components of a computer system.

[mag2]

Each client interface may include a separate set of registers to be used by a software client to obtain information about and configure the interface. Each set of registers may be accessible from outside the physical device over the same bus, be it serial or parallel, multi-drop or point to point. For example, a plug and play subsystem may use PCI configuration registers to define the base address of an MMIO region. A set of PCI-compatible configuration registers could include some or all of the following well-known registers: Vendor ID, Device ID (determines the offset of the configuration register addresses), Revision ID, Class Code, Subsystem Vendor ID, and Subsystem ID. A combination of these registers is typically used by an operating system to determine which driver to load for a device. [mag3] When implemented in the shareable device, each set of registers (of a given client interface) may be in the same address range except for a different offset.[mag4]

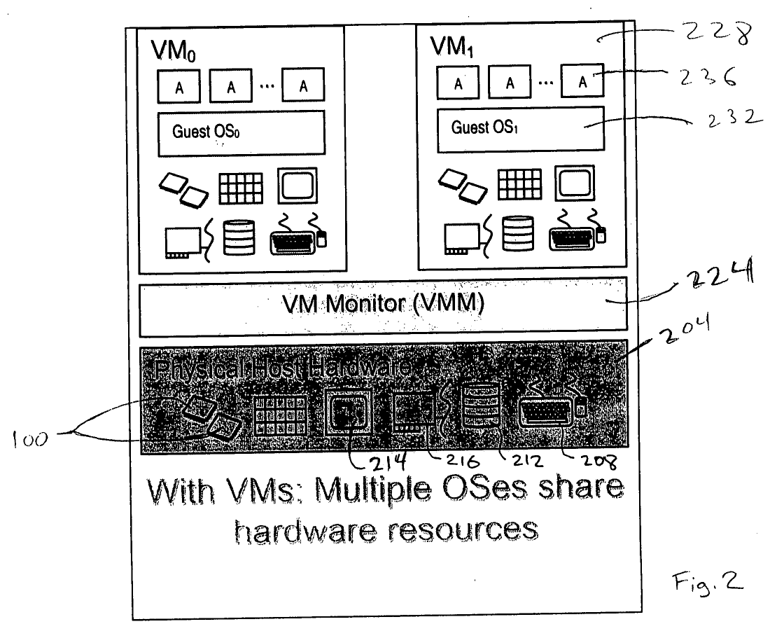

Setting a Base Address Register (BAR) may be used to specify the base address used by a device. [mag5] When the guest tries to set a BAR, the VMM may be designed to intercept this request and may modify it. This is for several reasons. First, each of two VMs may unknowingly attempt to set the BARs in an interface to the same value. The VMM may be designed to ensure this does not occur. Secondly, Each VM may believe it is running in a zero-based address space (so-called Guest Physical Addresses or GPA). When the BAR is to be set by a guest, the zero-based GPA should be translated into the actual Host Physical Address (HPA) before being loaded into the BAR. Furthermore, the VMM should modify the guest VM's memory management tables to reflect this translation.

[mag6] The shareable device 100 may be an even more desirable solution where the core function circuitry 104 is relatively complex and/or large, such that duplicating it would be too expensive (and the parallel processing performance gain from duplication is not needed). Another beneficial use would be in an I/O virtualization embodiment (as described below with reference to FIG. 2). In that case, the shareable device 100 allows the virtual machine monitor (VMM) to not be involved with every transaction, thereby shortening the latency of graphics and networking transactions (which are particularly sensitive to latency). In addition, in some embodiments, the design and implementation of the VMM could be substantially less complex, resulting in more stable operation of the software. That may be because having multiple client interfaces would obviate the need for the VMM to support corresponding virtual devices (e.g., the VMM need not emulate the device itself, nor the PCI configuration space for each virtual device[mag7].)

A software client may use any one of the client interfaces 112 to invoke the same primary function of the shareable device. This primary function may be that of an I/O device such as display graphics adapter, e.g. image rendering that generates the bit map display image. In that case, the shareable device may be implemented as part of the graphics I/O section of a computer system chipset, or as a single, graphics adapter card. The client interface in the latter case may also include an electrical connector for removably connecting the card to a bus of the computer system All of the interfaces in that case could be accessed through the same connector.

Another primary function may be that of a network interface controller (NIC). In such an embodiment, each software client (e.g., VM client 108) may be a separate end node in a network. The VM client 108 would communicate with the network via primary functions such as Transport Control Protocol/Internet Protocol (TCP/IP) packet offloading (creating outgoing packets and decoding incoming packets) and Media Access Control (MAC) address filtering. In that case, the shareable device may be a single network interface controller card. Each client interface presents the appearance of a complete or fully functional NIC, including a separate MAC address for each client interface. Incoming packets would be automatically routed to the correct client interface and then on to the corresponding VM client. This would be achieved without having to spend CPU cycles (VMM) to evaluate each incoming packet, and without the need to place the NIC into promiscuous mode in which the CPU examines each incoming packet regardless of whether or not the packet is intended for a VM in the system. [mag8]

It should be noted that although the client interfaces of the shareable device 100 may present themselves to a software client as complete, separate devices, they need not be identical devices. More generally, the shareable device 100 may have heterogeneous interfaces if one or more of its client interfaces 112 presents a different set of device capabilities (implemented in the core functionality 104) to the VM clients. For example, consider the case where the shareable device is a display graphics adapter. One of its client interfaces may appear to a software client as an older version of a particular device (e.g., a legacy device) while another appears to the software client as a newer version. As another example, consider a graphics adapter whose core I/O functionality is implemented as a scaleable computing architecture with multiple, programmable computing units. One of the client interfaces could be designed or programmed to access a larger subset of the computing units than another, so as to present the same type of but more powerful I/O functionality. [mag9]

In another example, the shareable device 100 may have some of its client interfaces be more complete, for example exposing higher performance capability (e.g. different types of graphics rendering functions in the core functionality). A more complex interface would most likely result in a correspondingly more complex device driver program associated with it. Accordingly, since a more complex device driver is more likely to have bugs or loop holes and be less amenable to security analysis, it would be deemed more vulnerable to attack. Thus, the interface in that case would be labeled untrusted or unsecure, due to its complexity. At the same time, the shareable device may have one or more other client interfaces that expose a lower performance version of the primary I/O function (e.g. basic image rendering and display only). The latter interfaces would as a result be deemed more trusted or more secure.

For example, an interface (by virtue of its complexity or inherent design) may be deemed sufficiently trusted to be relied upon to protect a user's secret data (e.g. data originating with and “owned” by the user of the system, such as the user's social security number and financial information). This interface (to a graphics device) may be used to exclusively display the output of certain application programs such as personal accounting and tax preparation software. This would, for example, help thwart an attack by a third party's rogue software component that has infiltrated the system and is seeking to gather confidential personal information about the user.

In another scenario, a less complex interface could be used for enhanced content protection, e.g. preventing the user of the system from capturing a third party's copyright protected data that appears either at the output of the core functionality. For example, the user may be running a DVD player application program on a particular VM client that is associated with a content protected interface only, such that the movie data stream is to only be rendered by that interface. Alternatively, the content protectiong client interface may be designed to be directly accessed by the application program, without an intermediate device driver layer. This type of simpler interface could further lessen the chances of attack, by providing fewer paths between the application program and the core graphics rendering and display functionality.

A single shareable device 100 having multiple client interfaces may be further enhanced by adding to it the capability of varying the number of active interfaces. This additional capability could be designed to give certain software running in the system, such as service VM 130 or VMM 224 (described below in connection with FIG. 2) access to configuration registers that enable/disable some of the client interfaces and not others. This helps control the allocation of resources within the I/O device, to for example better match the needs of the VM clients running in the system.

The shareable device 100 shown in FIG. 1 may also have one or more world interface circuits (or simply, world interfaces) 120. When more than one, the world interfaces are coupled to the core function circuitry 104 via additional multiplexing circuitry 122. Each world interface 120 may have digital and/or analog circuits that serve to translate between signaling in the core function circuitry 104 and signaling external to the device. The world interface may include connectors and/or other hardware needed to communicate with a computer system peripheral such as a display monitor or a digital camera, over a wired or wireless link. In the case of a network interface controller, the world interface may be referred to as a network port that connects to a local area network (LAN) node interconnection medium. This port may have circuits or wireless transmitters and receivers that connect with a LAN cable (e.g., an Ethernet cable) or communicate with for example a wireless access point.

In some embodiments, the shareable device 100 may be equipped with a control interface circuit (or simply, control interface) 126 that is to be used by software in the system referred to as service VM 130. The control interface 126 may be used for a variety of different purposes. For example, it may be a mechanism for combining data from the different clients (e.g. controlling where on the same display screen the output of each VM will be displayed). The control interface may also be used for resolving conflicting commands from the multiple VM clients[mag10]. For instance, it may provide another way to control access to the core functionality by the VM clients 108 (via their respective client interfaces 112). As an example, the control interface in a shareable graphics adapter may be designed to allow the service VM 130 to program the device with a particular scheduling policy for displaying multiple windows, e.g. one that does not give equal priority to all VM clients during a given time interval; one that allocates some but not all of the function blocks in the core functionality to a particular VM client. In such an embodiment, the shareable device may be further equipped with workload queues (not shown), one for each client interface 112 and coupled between the client interface 112 and the core function circuitry 104. The control interface would allow the service VM to select which queue feeds instructions to the core function circuitry, as a function of queue condition (e.g., its depth, how full or empty it is, its priority, etc.). [mag11]The control interface may also be used to configure how graphics is to be rendered and displayed, e.g. multi-monitor where each VM is assigned to a separate monitor, or multi-window in the same monitor. Power consumption of the graphics adapter may also be managed via the control interface. Note that in some cases, the shareable device may do without the control interface. For example, a shareable NIC may be simply programmed once (or perhaps hardwired) with an arbitration policy to service its different client interfaces fairly, or even unfairly if appropriate.

In the case of a NIC, the control interface may allow the service VM to change the bandwidth allocated or reserved on a per-VM client basis. In the case of a sound card, the control interface may allow the service VM to control mixing of audio from different VM client sources. Yet another possibility is to use the control interface to enable a video and/or audio capture stream to be routed to a specific VM client. For example, the control interface may be where software indicates the association of each of multiple, different media access controller (MAC) with their respective VM clients.

Turning now to FIG. 2, a block diagram of a computer system having a shareable device 100 and that is running a virtualization process is depicted. The shareable device 100 is part of the physical host hardware 204 of the system, also referred to as the bare metal. The host hardware 204 may include a set of available I/O devices (not shown) such as a keyboard controller, a hard disk drive controller, and a graphics display adapter. These serve to communicate with peripherals such as a user input device 208 (depicted in this example as a keyboard/mouse combination), a nonvolatile mass storage device (depicted here as a hard disk drive 212), a display monitor 214, and a NIC adapter card 216[mag12]. [mag13]

Virtualization is accomplished here using a program referred to as a Virtual Machine Monitor (VMM) 224. The VMM 224 “partitions” the host hardware platform 204 into multiple, isolated virtual machines (VMs) 228. Each VM 228 appears, to the software that runs within it, as essentially a complete computer system including I/O devices and peripherals as shown. The VMM 224 is responsible for providing the environment in which each VM 228 runs, and may be used to maintain isolation between the VMs (an alternative here would be the use of hardware CPU enhancements to maintain isolation).[mag14] The software running in each VM 228 may include a different guest OS 232. In a VM environment, each guest OS 232 has the illusion that it is running on its own hardware platform. A guest OS 232 thus may not be aware that another operating system is also running in the same system, or that the underlying computer system is partitioned.

The virtualization process allows application programs 236 to run in different VMs 228, on top of their respective guest operating systems 232. The application programs 236 may display their information simultaneously, on a single display monitor 214, using separate windows (one for each VM, for example). This is made possible by the shareable device 100 being in this example a graphics adapter. Note that the VMM 224 is designed so as to be aware of the presence of such a shareable device 100, and accordingly have the ability to manage it (e.g., via a service VM 130, see FIG. 1). However, many disadvantages of a purely software technique for sharing a physical device are avoided. For example, there may be no need to design and implement a fairly complex VMM that has to understand how the physical device works in detail, so as to be able to share it properly. This may be obviated by the availability of multiple, client interfaces, in hardware, that are readily recognizable by each guest OS 232.

Some additional benefits of the shareable device concept may be described by the following examples. Consider a multi-processor system, or one with a hyper-threaded central processing unit (CPU) where a single CPU acts as two or more CPUs (not just in a scheduling sense, but because there is enough execution capability remaining). Processor 1 is executing code for VM0, and processor 2 is executing code for VM1. Next, assume that each VM wishes to access the same I/O device simultaneously. A non-shareable I/O device can only be operating in one context at any point in time. Therefore, only one of the VMs can access the device. The other VM's attempt to access the device would result it in its accessing the device in the wrong context.

An embodiment of the invention allows de-coupling the “conversation” (between a VM and a hardware client interface) and the “work” (being done by the core function circuitry), such that the context switch described above may not be needed. That is because each VM is assigned its separate hardware client interface so that the VMs can send the I/O requests to their respective client interface circuits without a context switch of the I/O device being needed. This provides a solution to the access problem described above.

As another example, consider a CPU running both VM0 and VM1. In VM0, the application software is making relatively heavy use of the CPU (e.g., calculating the constant pi) but asking very little of the graphics adapter (e.g., updating the clock in a display window). In the other VM window, a graphics pattern is being regularly updated by the graphics adapter, albeit with little use of the CPU. Now, assume that the CPU and the graphics adapter are context switched together (giving the graphics adapter and CPU to VM0 part of the time and to VM1 the rest of the time). In that case, the relatively light graphics demand by VM0 results in wasted/idle graphics cycles part of the time, and the light CPU demand of VM1 produces wasted/idle CPU cycles the rest of the time. That is because both the CPU and the graphics adapter core functionality are always in the same context. This inefficient use of the system resources may be avoided by an embodiment of the invention that allows the CPU workload to be scheduled independently of the graphics adapter workload. With different hardware client interfaces available in the graphics adapter, the CPU may be scheduled to spend most of its time executing for VM0 and still get access to the graphics adapter occasionally. On the other hand, the core functionality of the graphics adapter may be scheduled to spend most of its time on VM1, and may be interrupted occasionally to service VM0.

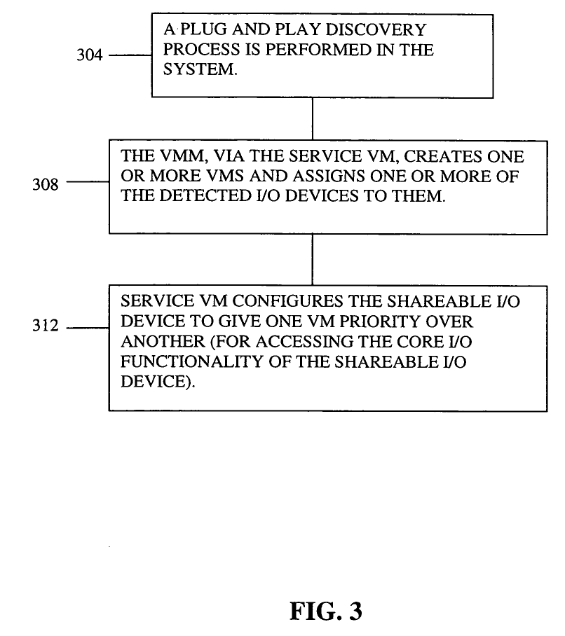

Turning now to FIG. 3, a flow diagram of a virtualization process involving the discovery and sharing of a shareable I/O device in a computer system is depicted. The system may be the one shown in FIG. 2. The method begins with operation 304 in which a plug and play discovery process is performed in the system. As an example, this may be part of a conventional PCI device and function enumeration process (also referred to as a PCI configuration process). The discovery process may detect the multiple I/O devices as a result of reading a unique PCI device identification number for each device, from the different client interfaces of a single, graphics adapter card. This may occur after powering-on the system, by a Basic I/O System firmware (BIOS) and/or the VMM being executed by a processor of the system. The adapter card is an example of a shareable I/O device whose core I/O functionality will be shared by its multiple, hardware client interfaces. The discovery process may also detect another device in the form of the control interface 126 (see FIG. 2).

In an alternative embodiment, the BIOS, during initial boot, may discover just the control interface. Some time later, the VMM may use the control interface to create one or more client interfaces as needed. These interfaces could be created all at once, or created on demand. Upon creation of each interface, the VMM would see a hot plug event indicating the “insertion” of the newly-created interface. See for example U.S. patent application Ser. No. 10/794,469 entitled, “Method, Apparatus and System for Dynamically Reassigning a Physical Device from One Virtual Machine to Another” by Lantz et al., filed Mar. 5, 2004 and assigned to the same assignee as that of the present application. [mag15]

The method proceeds with operation 308 in which the VMM, or the Service VM, creates one or more VMs and assigns one or more of the detected I/O devices to them. In this example, each detected device is the graphics adapter of a respective VM in the system. The Service VM may then be used to configure the adapter, via its control interface, so that its core I/O functionality is shared according to, for example, a priority policy that gives one VM priority over another (operation 312). Thereafter, once the VMs are running, the VMM may stand back and essentially not involve itself with I/O transactions, because each VM can now easily modify or intercept its OS calls that are directed to display graphics (e.g., by adding an address offset to point to its assigned hardware client interface.)

Some embodiments of the invention may be provided as a computer program product or software which may include a machine or computer-readable medium having stored thereon instructions which may be used to program a computer (or other electronic devices) to perform a process according to an embodiment of the invention. In other embodiments, operations might be performed by specific hardware components that contain microcode, hardwired logic, or by any combination of programmed computer components and custom hardware components.

A machine-readable medium may be any mechanism that provides, i.e. stores or transmits, information in a form accessible by a machine (e.g., a set of one or more processors, a desktop computer, a portable computer, a manufacturing tool, or any other device that has a processor). E.g., recordable/non-recordable media such as read only memory (ROM), random access memory (RAM), magnetic rotating disk storage media, optical disk storage media, as well as electrical, optical, acoustical or other form of propagated signals (e.g., carrier waves, infrared signals, etc.)

To summarize, various embodiments of a technique for sharing a physical device among multiple clients have been described. In the foregoing specification, the invention has been described with reference to specific exemplary embodiments thereof. It will, however, be evident that various modifications and changes may be made thereto without departing from the broader spirit and scope of the invention as set forth in the appended claims. For example, the computer system in which the VMM will be running may have multiple processors (CPUs), where each VM client may for example be running on a different processor. The multiple client interfaces of a shareable device in such a system allow access to the same core functionality of the device, by different VM clients, to occur simultaneously, without the VM clients being aware of each other. This would occur without the VM clients interfering with each other, from their own point of the view. Simultaneous access in this context means for example that a transaction request is being captured by the I/O device but has not yet completed, and another transaction request is also being captured by the I/O device and has not completed. In a non-virtualized system, the OS typically ensures that such a scenario is not allowed, e.g. no two CPUs are allowed to program the same device at the same time. However, in an embodiment of the VM system described here, it is desirable that the VMM not have to take on such a responsibility (due to the complexity of such software that would need to monitor or be involved with every access to an I/O device). Accordingly, in such a system, there is no coordination between the VM clients or guests as they are accessing the same I/O device. Such accesses however are properly routed to the core functionality of the I/O device due to the nature of the multiple client interfaces described above, making the solution particularly attractive for multiprocessor VM systems. The specification and drawings are, accordingly, to be regarded in an illustrative rather than a restrictive sense.

What is claimed is:

1. A physical device comprising:
core function circuitry that is to perform a core function of a computer system;
a plurality of client interface circuits each of which presents itself as a complete device to a software client in the system to access the core function circuitry; and
multiplexing circuitry that couples the plurality of client interface circuits to the core function circuitry.

2. The device of claim 1 wherein the core function is a primary function of a display graphics adapter.

3. The device of claim 1 wherein the primary function is image rendering.

4. The device of claim 1 wherein the core function is a primary function of a network interface controller.

5. The device of claim 4 wherein the primary function is TCP/IP packet offloading.

6. The device of claim 1 wherein the client interfaces expose different I/O device capabilities to a software client.

7. The device of claim 1 wherein one of the client interfaces exposes a trusted graphics adapter and another one exposes an untrusted graphics adapter.

8. The device of claim 1 wherein each of the plurality of client interfaces has a separate set of registers to configure operation of the core function circuitry,
and wherein one set appears to a software client as an older version of an I/O device and another set appears to the software client as a newer version of said I/O device.

9. The device of claim 1 further comprising:
a control interface circuit that is to be used by service virtual machine (VM) software in the system to control access by a plurality of VMs in the system to the core function circuitry, wherein the plurality of VMs are to access the core function circuitry via the plurality of client interface circuits, respectively.

10. The device of claim 9 wherein the core function is a primary function of a display graphics adapter, and the control interface allows the service VM software to select how to display a plurality of windows for the plurality of VMs, respectively, using the core function circuitry.

11. The device of claim 1 further comprising:
a plurality of world interface circuits that are coupled to the core function circuitry via additional multiplexing circuitry, to translate between signaling in the core function circuitry and signaling external to the device.

12. The device of claim 11 wherein the plurality of world interface circuits are to translate between signaling in the core function circuitry and signaling in a computer peripheral bus.

13. The device of claim 11 wherein the plurality of world interface circuits are to translate between signaling in the core function circuitry and signaling in a LAN node interconnection medium.

14. The device of claim 9 further comprising a plurality of workload queues each coupled between a separate one of the plurality of client interface circuits and the core function circuitry, wherein the control interface circuit allows the service VM to select which queue is to feed the core function circuitry as a function of queue condition.

15. An I/O device comprising:
core I/O function circuitry to perform a core I/O function of a computer system; and
a plurality of client interface circuits any one of which can be used by a virtual machine (VM) in the system to access the core I/O function circuitry to invoke the same core I/O function.

16. The I/O device of claim 15 wherein each of the client interface circuits has a separate set of a registers that are accessible from outside the I/O device, and each set has the same address range except for an offset.

17. The I/O device of claim 15 wherein one of the client interface circuits presents a content protection interface to graphics adapter fucntionality to thwart unauthorized copying of output data that is rendered by the graphics adapter functionality, and another one of the client interface circuits presents an unsecure interface to the graphics adapter functionality.

18. The I/O device of claim 15 wherein the I/O device can give software an ability to change the number of client interfaces at will to better match the resources of the I/O device to the needs of a plurality of virtual machine clients that will access the I/O device through the plurality of client interface circuits, respectively.

19. A computer system with virtual machine capability, comprising:
a processor;
a memory having a virtual machine monitor (VMM) stored therein, wherein the VMM is to be accessed by the processor to manage a plurality of virtual machines (VMs) in the system for running a plurality of client programs, respectively; and
an I/O device having a plurality of interfaces in hardware where each interface presents itself as a separate I/O device to a respective one of the plurality of client programs that will be running within the plurality of VMs.

20. The system of claim 19 wherein the memory further includes a service VM stored therein to be accessed by the processor,
and the I/O device further comprises a control interface in hardware to be used by the service VM to configure the core I/O function circuitry.

21. The system of claim 20 wherein the I/O device further comprises:
a world interface in hardware that is to translate between signaling of the core I/O function circuitry and signaling external to the I/O device.

22. A virtualization apparatus comprising:
means for performing a core I/O function of a computer system;
means for presenting a plurality of complete interfaces to a plurality of virtual machine (VM) clients for accessing the core I/O function, wherein each interface is complete in that it can be accessed as a separate I/O device by the same device driver; and
means for passing messages between the core I/O function performance means and the complete interface presentation means.

23. The virtualization apparatus of claim 22 wherein each of the complete interfaces presents a separate I/O device that has a) a unique device identification number and b) a separate set of configuration registers that are exposed on the same bus.

24. The virtualization apparatus of claim 23 wherein each set of configuration registers is to store a separate PCI device ID, Vendor ID, Revision ID, and Class Code.

25. A method for sharing an I/O device, comprising:
performing a plug and play discovery process in a computer system; and
detecting by said process that a plurality of I/O devices are present in the system, when in actuality the detected I/O devices are due to a single physical I/O device being connected to the system and in which its core I/O functionality is shared by a plurality of hardware client interfaces in the physical I/O device.

26. The method of claim 25 wherein the detecting includes reading a unique PCI device identification number for each of the detected I/O devices from a single graphics adapter card that contains the shared core I/O functionality.

27. The method of claim 25 further comprising:
assigning the plurality of detected I/O devices to a plurality of virtual machines (VMs), respectively, in the system.

28. The method of claim 27 further comprising:
configuring the core I/O functionality to be shared, when servicing the plurality of VMs, according to a priority policy that gives one of the VMs priority over another.

29. An article of manufacture having a machine-readable medium with data stored therein that, when accessed by a processor in a computer system, writes to and reads from a control interface of a physical device in the system to control access to the same core functionality of the device by a plurality of client interfaces in hardware each of which presents itself as a complete device to a device driver program in the system.

30. The article of manufacture of claim 29 wherein the data is part of virtualization software for the system.

31. The article of manufacture of claim 30 wherein the data is such that the writes and reads program the physical device with a scheduling policy for the core functionality to render and display images from the client interfaces in a plurality of display windows, respectively.

32. The article of manufacture of claim 30 wherein the data is such that they program the physical device to select which queue associated with one of the plurality of client interfaces feeds instructions to the core functionality.

33. The article of manufacture of claim 30 wherein the data is such that the writes and reads perform power management operations upon the physical device.

34. The article of manufacture of claim 30 wherein the data is such that the writes and reads are directed to routing an external capture stream to one of the client interfaces.

35. A mutliprocessor computer system with virtual machine capability, comprising:
a plurality of processors;
a memory having a virtual machine monitor (VMM) stored therein, wherein the VMM is to be run by one of the processors to manage a plurality of virtual machines (VMs) in the system for running a plurality of client programs, respectively; and
an I/O device having core functionality and a plurality of interfaces in hardware each of which presents itself as a separate I/O device to a respective one of the plurality of client programs that will be running within the plurality of VMs, wherein the plurality of VMs can simultanously access the core functionality of the I/O device via the plurality of interfaces without being aware of each other and without the VMM having to arbitrate between the plurality of VMs.
